(19) United States
(12) Patent Application Publication
(10) Pub. No.: US 2007/0199977 A1
(43) Pub. Date: Aug. 30, 2007

(54) Turbocharger turbine and shaft assembly

(76) Inventors: Michael Pollard, Peoria, IL (US); Stephen John O'Hara, Zionsville, IN (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/364,451

(22) Filed: Feb. 28, 2006

(51) Int. Cl. A47J 36/02

(52) U.S. Cl. 228/101

(57) ABSTRACT

The present disclosure includes a turbocharger. The turbocharger may include a titanium-aluminide turbine and a shaft. A single joint connects the turbine to the shaft. The joint may include an alloy comprising at least 80 atomic percent nickel and palladium.

### U.S. GOVERNMENT RIGHTS

This invention was made with government support under the terms of Contract No. DE-AC05-000R22725 awarded by the Department of Energy. The government may have certain rights in this invention.

### TECHNICAL FIELD

This disclosure pertains generally to turbochargers for engines, and more particularly, to methods for fabricating turbine and shaft assemblies for turbochargers.

### BACKGROUND

Turbochargers can be used to control the power output of an engine by providing additional air to the engine cylinders. Generally, a turbocharger may include an exhaust gas driven turbine connected to a rigid shaft. Rotation of the turbine will transmit mechanical energy through the shaft to drive a compressor, which will in turn force additional air into the engine cylinders. Because turbocharger components may be subject to relatively high mechanical stresses, the turbine and shaft must be produced from high-strength materials. Further, the turbine and shaft may be produced from different materials, which must be connected at a strong joint that can withstand cyclic stresses and repeated temperature fluctuations.

Titanium-aluminide constitutes a lightweight, strong material that may be used to produce turbocharger turbines. However, the use of titanium-aluminide can complicate joining of the turbine to the turbocharger shaft, which is often made with steel. Titanium-aluminide and steel may have different thermal expansion properties and may produce undesirable phase transformations at their material interfaces. Therefore, when used for applications that experience significant temperature variations, such as turbocharger components, titanium-aluminide and steel may be unsuitable for joining directly to one another.

One method of joining titanium-aluminide turbines to steel shafts is disclosed in U.S. Pat. No. 6,291,086 (hereinafter the '086 patent), which issued on Sep. 18, 2001, to Nguyen-Dinh. The method describes the use of an interlayer material disposed between a titanium-aluminide turbine and steel shaft. In the method of the '086 patent, the interlayer material is welded to both the titanium-aluminide turbine and steel shaft. Therefore, although the method of the '086 patent may provide a suitable connection between the turbine and shaft, two welds must be made and an additional material must be used, which can add significant time and cost to production.

The present disclosure is directed at overcoming one or more of the problems or disadvantages existing in the prior art turbochargers.

### SUMMARY OF THE INVENTION

One aspect of the present disclosure includes a turbocharger. The turbocharger may include a titanium-aluminide turbine and a shaft. A single joint connects the turbine to the shaft. The joint may include an alloy comprising at least 80 atomic percent nickel and palladium.

A second aspect of the present disclosure includes a method of producing a turbocharger. The method includes producing a titanium-aluminide turbine and a shaft. The method further includes joining the turbine to the shaft with a single joint including an alloy comprising at least 80 atomic percent nickel and palladium.

A third aspect of the present disclosure is a machine. The machine includes a power source, an exhaust system operably connected to the power source, and a turbocharger. The turbocharger includes a titanium-aluminide turbine and a shaft. A single joint connects the turbine to the shaft. The joint may include an alloy comprising at least 80 atomic percent nickel and palladium.

### BRIEF DESCRIPTION OF THE DRAWINGS

The accompanying drawings, which are incorporated in and constitute a part of this specification, illustrate exemplary embodiments of the disclosure and, together with the written description, serve to explain the principles of the disclosure. In the drawings:

FIG. 1 illustrates a machine including a turbocharger according to an exemplary disclosed embodiment.

FIG. 2 illustrates a turbine and shaft of the present disclosure before being joined.

FIG. 3 illustrates an exemplary turbine and shaft of FIG. 2 after being connected at a single joint.

### DETAILED DESCRIPTION

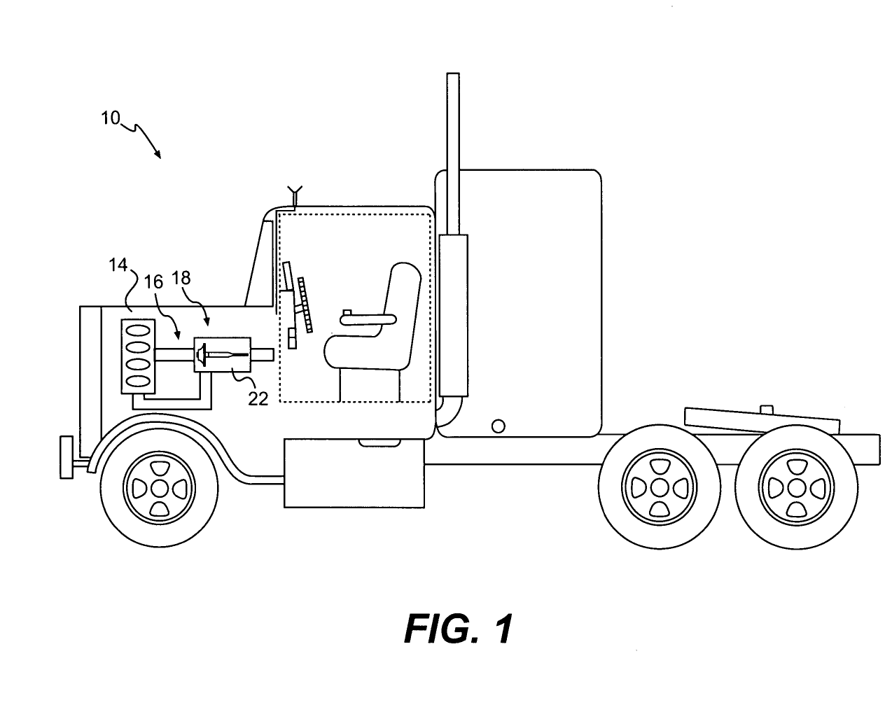

FIG. 1 illustrates a machine 10 including a turbocharger 18 according to an exemplary disclosed embodiment. As shown, machine 10 includes a power source 14 and exhaust system 16. Power source 14 may include any suitable engine type, including a diesel engine or gasoline engine. Power source 14 may be configured to supply an exhaust gas stream to exhaust system 16. As shown, machine 10 includes a highway truck. However, machine 10 may include any machine having an engine and turbocharger. For example, such machines may include off-highway trucks, trains, earth movers, boats, and/or any other machine that includes one or more turbochargers.

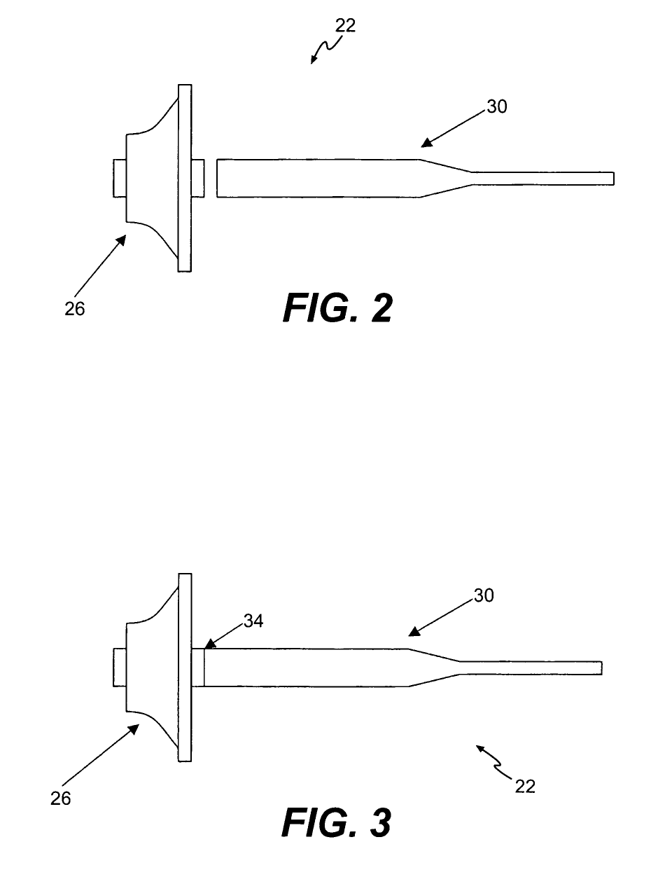

Turbocharger 18 may be positioned downstream of engine 14 and may be configured to increase the amount of air flowing into the cylinders of engine 14, thereby increasing the power output of engine 14. Turbocharger 18 may include a turbine and shaft assembly 22. As described below, turbine and shaft assembly 22 may include a turbine 26, which may be connected to a shaft 30 at a single joint 34 (shown in FIG. 2). Turbine 26 may be operably connected with an exhaust passage of exhaust system 16, and an exhaust gas stream flowing through the exhaust passage may cause turbine 26 and shaft 30 to rotate. Further, shaft 30 may be operably connected to a compressor (not shown), which may be configured to supply air to an intake passage of engine 14. Rotation of turbine 26 and shaft 30 may provide power to the compressor, thereby increasing the intake air and power output of engine 14.

FIG. 2 illustrates turbine 26 and shaft 30 of the present disclosure before being joined. Turbine 26 and shaft 30 may include a variety of different shapes, sizes, and configurations. Further, turbine 26 and shaft 30 may be produced from a number of suitable materials. The specific shape, size, configuration, and materials may be selected based on a desired power output, cost, and/or size constraints. Further, the design and materials may be selected based on expected environmental conditions, including, for example, expected mechanical stresses and temperature fluctuations

Turbine 26 can be made from a variety of materials. In one embodiment, turbine 26 may be made from one or more materials including for example, titanium-aluminide. The titanium-aluminide included in turbine 26 may be selected from a number of titanium-aluminide compositions. Titanium-aluminides that may be suitable for use with turbine 26 include, for example, gamma-TiAl, TiAl, Ti₃Al, TiAl₃, Ti-48Al-2Nb-2Cr, and Ti₂AlNb.

Shaft 30 may also be produced from a number of different materials. For example, in some embodiments, shaft 30 may be produced from steel. A variety of different steels may be selected to produce shaft 30. For example, the steel used to produce shaft 30 may be selected based on desired strength, cost, necessary heat treatment or other processing steps, machinability, weight, and/or any other suitable factor. In some embodiments, ANSI 1040 steel may be selected, but any suitable steel may be used to produce shaft 30.

As noted previously, turbine 26 may be operably connected to shaft 30 at single joint 34. FIG. 3 illustrates turbine 26 and shaft 30 of FIG. 2 after being connected at single joint 34. Joint 34 may be formed in a variety of ways. In one embodiment, joint 34 may be formed using a brazing process. In some embodiments, the brazing process may be performed using a brazing material including palladium and nickel. In some embodiments, the brazing materials may include nickel, palladium and silicon.

Generally, brazing is a joining process whereby a filler metal and an alloy are heated to their melting temperature and distributed between two or more close-fitting parts (e.g. turbine 26 and shaft 30). At its liquid temperature, the molten filler metal interacts with a thin layer of the base metal, and cools to form a strong, sealed joint. The brazed joint becomes a sandwich of different layers, each metallurgically linked to each other.

Before joining turbine 26 and shaft 30 by brazing, it may be desirable to clean and/or polish the surfaces to be joined. A variety of suitable cleaning and polishing processes may be selected. For example, suitable cleaning processes may include combinations of chemical and/or mechanical cleaning processes. Any suitable cleaning process may be selected to remove grease, dirt, and/or debris from surfaces of turbine 26 and shaft 30 to be joined. Likewise, the surfaces may be polished to produce smooth surfaces, which may facilitate formation of a strong joint by brazing.

After cleaning and/or polishing, the surfaces of turbine 26 and shaft 30 to be joined may be approximated. Generally, it is desirable to maintain a small gap between the surfaces of materials to be joined by brazing. A range of gap widths may be selected depending on the brazing material being used. For example, the gap width may be between about 1 micron and about 75 microns. For the brazing materials of the present disclosure, a gap width of about 40 microns and 60 microns may be selected, but a range of suitable gap widths may be used.

In order to control the gap width, a spacer material may be placed between the surfaces to be joined. Generally, the spacer material will be a small object located at the center of the joint, thereby allowing the brazing material to fill most of the joint space. Any material having a melting temperature higher than that of the brazing material may be used to produce the spacer material. Further, in some embodiments, the spacer may include a protrusion in the surface of either shaft 30 or turbine 26.

After cleaning, polishing and positioning the surfaces, the brazing material may be heated past its melting point and applied to the interface between turbine 26 and shaft 30. Heating may be accomplished in a number of ways. For example, the brazing process may be performed in a number of different atmospheres. In some embodiments, it may be desirable to perform the brazing process in an inert atmosphere such as argon. Alternatively, brazing may be performed in a vacuum. In addition, a number of heating systems may be used. For example, heating may be effected using a furnace with a vacuum or an inert gas.

In some embodiments, it may be desirable to use a heating process that provides rapid heating of the brazing material and joint surfaces. A rapid heating process will reduce the time that the brazing material and surfaces to be joined spend at elevated temperatures. In some embodiments, induction heating may be selected to rapidly heat the brazing material and joint surfaces.

A variety of materials may be selected as brazing materials. In some embodiments, the brazing material may include palladium and nickel. The specific amounts of palladium and nickel may be selected based on a number of factors. For example, the relative amount of palladium and nickel may be selected based on cost and/or desired strength. Further, the amount of palladium and nickel may be selected to control the melting point of the brazing material. In some embodiments, nickel and palladium will comprise at least about 80 atomic percent of the brazing material. Further, in some embodiments, nickel and palladium will comprise at least about atomic percent of the brazing material.

As noted, the relative amounts of palladium and nickel may be selected based on a number of factors. For example, it may be desirable to minimize the melting point of nickel and palladium alloys used for brazing. Nickel and palladium are known to be completely soluble in one another, so a range of suitable compositions may be used. Further, alloys of palladium and nickel will generally have a lower melting point than either of the base metals. In some embodiments, the brazing material may include a ratio of palladium to nickel between about 2:3 and about 3:2 calculated based on atomic percent. These compositions correspond to the minimum melting point for palladium-nickel alloys. Further, in some embodiments, palladium and nickel may be provided in approximately equal quantities.

The brazing material may further include other components. For example, silicon may be added to the brazing material to further reduce the melting point of the material, to decrease the material cost, and/or to affect wetting properties of the material. A range of silicon compositions may be selected. For example, the brazing material may include between about 0% and about 10% (atomic) silicon, or between about 5% and about 7% (atomic) silicon. One exemplary brazing alloy that includes palladium, nickel, and silicon is Palnisis™-47, which is produced by Wesgo Metals and includes 47% palladium, 47% nickel, and 6% silicon, calculated as atomic percent. This material also has a liquidus temperature of about 851° C., which is below the melting point of steel and titanium-aluminide.

In some embodiments, the brazing material may be selected to include substantially no boron. Boron may form hard borides with nickel, titanium, iron, or other metals present in turbine 26, shaft 30, or the selected brazing material. Excess borides may cause joint 34 to become brittle, thereby increasing failure rates. It should be understood that most metals and alloys will contain small amounts of additives or contaminants. In some embodiments, the brazing material may include pallium, nickel, and silicon and less than about 2 atomic percent boron, less than about 1 atomic percent boron, or less than 0.5 atomic percent boron.

The specific heating time and temperature may be selected based on a number of factors. For example, the heating time and temperature may be selected based on the size (e.g. cross sectional diameter) of joint 34. The heating time may be selected to allow the brazing material to fill substantially all of the gap between shaft 30 and turbine 26, while limiting the time that shaft 30 and turbine 26 spend at elevated temperatures. Depending on the size of shaft 30 and turbine 26, exemplary heating times may be between about 5 seconds and 3 minutes using induction heating at about 900° C. Typical heating times for a 2 inch diameter shaft using induction heating at about 900° C. may be about 20 seconds to about 40 seconds. Further, a range of temperatures may be selected. For example, suitable temperatures may be between about 860° C. and about 1000° C. or between about 875° C. and about 900° C. Any suitable temperature and heating time may be selected.

After brazing, it may be desirable to anneal turbine and shaft assembly 22. Annealing may increase the strength of joint 34 by reducing solidifications stresses that may have formed or by effecting phase transformations within joint 34 or at material interfaces. Further, annealing may be used to temper the steel used to produce shaft 30, thereby increasing the strength of shaft 30 and preventing or reducing deformation or cracking during use.

Annealing may be performed using a furnace with a range of heating times and temperatures. The specific heating time and temperature may depend on the specific type of steel used to produce shaft 30 or based on the size of turbine and shaft assembly 22. In some embodiments, annealing may be performed by heating turbine and shaft assembly 22 to between about 500° C. and about 750° C. for between about 15 minutes and about 1 hour. In some embodiments, turbine and shaft assembly 22 may be heated to between about 600° C. and about 700° C. or to between about 625° C. and about 675° C. for about 30 minutes. Any suitable heating time and temperature may be selected.

### INDUSTRIAL APPLICABILITY

The present disclosure provides a turbocharger turbine and shaft assembly 22 having a strong, durable joint 34 connecting the turbine 26 and shaft 30. This turbocharger may be useful with any engine and exhaust system that incorporates turbochargers.

The turbocharger of the present disclosure includes a titanium-aluminide turbine 26 joined via a single joint 34 to a shaft 30. The shaft 30 may be produced from any suitable material, including any suitable steel. The joint 34 connecting the shaft 30 to the turbine 34 may be produced using a palladium-nickel brazing alloy. In some embodiments, the brazing alloy will include a palladium-nickel-silicon alloy.

The brazing material may be used to produce a high strength joint between titanium-aluminide turbines and steel shafts. Palladium-nickel-silicon alloys may have relatively low melting points compared to other brazing materials. Because of the lower melting point, the brazing process used to connect the turbine 26 and shaft 30 may be performed at relatively low temperatures. The lower brazing temperatures may reduce dissolution of titanium-aluminide and steel within the braze material, thereby preventing formation of a weaker joint material formed from components of the brazing materials and turbine and/or shaft materials. Further, the lower brazing temperatures may prevent undersirable phase transformations within or around the brazed joint. In addition, the palladium-nickel-silicon materials may include substantially no boron. Boron may cause borides, such as titanium boride, to form in or around the joint. In some cases, the borides may increase the brittleness of the joint and increase failure rates due to cracking.

Finally, the brazing process of the present disclosure may produce durable joints with relatively high throughput and low cost. As noted previously, the brazing material may be melted at a relatively low temperature. The low temperature will decrease the required heating time, thereby reducing production time, increasing production throughput, and reducing production cost.

It will be apparent to those skilled in the art that various modifications and variations can be made in the disclosed systems and methods without departing from the scope of the disclosure. Other embodiments of the disclosed systems and methods will be apparent to those skilled in the art from consideration of the specification and practice of the embodiments disclosed herein. It is intended that the specification and examples be considered as exemplary only, with a true scope of the disclosure being indicated by the following claims and their equivalents.

What is claimed is:

1. A turbocharger comprising:
a turbine including titanium-aluminide;
a shaft; and
a single joint connecting the turbine to the shaft and including an alloy comprising at least 80 atomic percent nickel and palladium.

2. The turbocharger of claim 1, wherein the shaft includes steel.

3. The turbocharger of claim 1, wherein the joint includes an alloy comprising at least about 90 atomic percent nickel and palladium.

4. The turbocharger of claim 3, wherein the alloy further includes silicon.

5. The turbocharger of claim 4, wherein the alloy includes between about 5 atomic percent and about 7 atomic percent silicon.

6. The turbocharger of claim 4, wherein the alloy consists essentially of palladium, nickel, and silicon.

7. The turbocharger of claim 4, wherein the joint includes substantially no borides.

8. A method of producing a turbocharger comprising:
producing a turbine including titanium-aluminide;
producing a shaft; and
joining the turbine with the shaft using a single joint including an alloy comprising at least 80 atomic percent nickel and palladium.

9. The method of claim 8, wherein joining the turbine with the shaft includes brazing the turbine to the shaft to form the single joint.

10. The method of claim 9, wherein the brazing is performed using induction heating.

11. The method of claim 10, wherein the induction heating is performed in an argon atmosphere.

12. The method of claim 9, wherein the brazing includes heating the alloy to a temperature between about 860° C. and about 1000° C.

13. The method of claim 12, wherein the alloy is heated for a time between about 5 seconds and about 3 minutes.

14. The method of claim 12, wherein the alloy is heated for a time between about 20 seconds and about 40 seconds.

15. The method of claim 9, wherein the brazing includes heating the alloy to a temperature between about 875° C. and about 900° C.

16. The method of claim 9, further including annealing the joined turbine and shaft.

17. The method of claim 16, wherein annealing the joined turbine and shaft includes heating the turbine and shaft to a temperature of between about 600° C. and about 700° C. for about 30 minutes.

18. The method of claim 9, wherein the brazing is performed using an alloy comprising at least about 90 atomic percent nickel and palladium.

19. The method of claim 18, wherein the alloy further includes silicon.

20. The method of claim 19, wherein the alloy includes between about 5 atomic percent and about 7 atomic percent silicon.

21. The method of claim 19, wherein the alloy consists essentially of palladium, nickel, and silicon.

22. The method of claim 19, wherein the alloy includes substantially no boron.

23. A machine comprising:
a power source;
an exhaust system operably connected to the power source; and
a turbocharger disposed within the exhaust system, wherein the turbocharger includes:
a turbine including titanium-aluminide;
a shaft; and
a single joint connecting the turbine to the shaft and including an alloy comprising at least 80 atomic percent nickel and palladium.

24. The machine of claim 23, wherein the shaft includes steel.

25. The machine of claim 23, wherein the joint includes an alloy comprising at least about 90 atomic percent nickel and palladium.

26. The machine of claim 25, wherein the alloy further includes silicon.

27. The machine of claim 26, wherein the alloy includes between about 5 atomic percent and about 7 atomic percent silicon.

28. The machine of claim 26, wherein the alloy consists essentially of palladium, nickel, and silicon.

29. The machine of claim 26, wherein the alloy includes substantially no boron.
